(19) United States
(12) Patent Application Publication
(10) Pub. No.: US 2014/0198492 A1
(43) Pub. Date: Jul. 17, 2014

(54) Waterproof-breathable Structure for Flashlight

(71) Applicant: Shih-Hao Wang, Tainan City (TW)

(72) Inventor: Shih-Hao Wang, Tainan City (TW)

(21) Appl. No.: 13/741,431

(22) Filed: Jan. 15, 2013

(51) Int. Cl. F21V 31/00

(52) U.S. Cl. CPC F21V 31/00
USPC 362/158

(57) ABSTRACT

A waterproof-breathable structure for a flashlight includes a housing and a ventilative plug. The housing is penetrated by a hole with one or more chamfered segments, and the ventilative plug has an outer diameter greater than the hole to be closely fit therein. The ventilative plug has a capping portion, an abutting flange extending from an outer part thereof, and a rim extending from an inner part thereof. Thereby, inner pressure generated in the flashlight due to battery oxidation over time is allowed to escape through an interval formed between an inward retracted periphery of the ventilative plug and the chamfered segments formed at the inner periphery of the housing hole, while the ventilative plug closely fit in the hole of the housing of the flashlight serves to effectively prevent external moisture from incursion.

### BACKGROUND OF THE INVENTION

1. Technical Field

The present invention relates to a waterproof-breathable structure for a flashlight that includes a housing and a ventilative plug. The housing is penetrated by a hole with one or more chamfered segments and allows the ventilative plug that has an outer diameter greater than the hole to be closely fit therein. The ventilative plug has a capping portion, an abutting flange extending from an outer part thereof, and a rim extending from an inner part thereof. Thereby inner pressure generated in the flashlight due to battery oxidation over time is allowed to escape through an interval formed between an inward retracted periphery of the ventilative plug and the chamfered segments formed at the inner periphery of the housing hole, while the ventilative plug closely fit in the hole effectively prevents external moisture from incursion.

2. Description of Related Art

There are many types of flashlights on the market, each having a configuration designed particularly for certain usage. One thing in common among them is that, as a lighting tool, they are required to meet particular standards, such as the Underwriters Laboratories (UL) standards. The present invention is made to exceed theses standards by providing a waterproof breathable structure for a flashlight, which enables the flashlight to have improved breathability and waterproofability either in use or in storage, and thereby have improved user safety.

### SUMMARY OF THE INVENTION

The present invention provides improvements to the existing flashlight assemblies for particular lighting applications, so as to provide breathability and waterproofability in use thereof. According to the present invention, a waterproof-breathable structure includes a housing penetrated by a hole with one or more chamfered segments to allow a ventilative plug that has an outer diameter greater than the hole to be closely fit therein. The ventilative plug has a capping portion, an abutting flange extending from an outer part thereof, and a rim extending from an inner part thereof. Thereby inner pressure generated in the flashlight due to battery oxidation over time is allowed to escape through an interval formed between an inward retracted periphery of the ventilative plug and the chamfered segments formed at the inner periphery of the housing hole, while the ventilative plug closely fit in the hole effectively prevents external moisture from incursion.

The primary objective of the present invention is to provide a waterproof-breathable structure for a flashlight, wherein the waterproof-breathable structure is configured to make the flashlight waterproof yet breathable, and comprising a housing and a ventilative plug, in which the housing is at an appropriate site penetrated by a hole that has an inner periphery provided with one or more chamfered segments and allows the ventilative plug that has an outer diameter greater than the hole to be closely fit therein closely fit therein, while the ventilative plug has a capping portion at a predetermined section thereof, an abutting flange extending from an outer part thereof, and a rim extending from an inner part thereof, in which where the ventilative plug contacts the housing hole achieves full roundness, so that the ventilative plug when assembled in the housing hole forms interference fit with the hole, whereby inner pressure generated in the flashlight due to battery oxidation over time is allowed to escape through an interval formed between an inward retracted periphery of the ventilative plug and the chamfered segments formed at the inner periphery of the housing hole, while the ventilative plug closely fit in the hole of the housing of the flashlight serves to effectively prevent external moisture from incursion.

The second objective of the present invention is to provide a waterproof-breathable structure for a flashlight, wherein the capping portion at the predetermined section of the ventilative plug assembled into the hole of the housing of the flashlight has a thickness preferably not greater than 4 mm.

The third objective of the present invention is to provide a waterproof-breathable structure for a flashlight, wherein the ventilative plug assembled into the hole of the housing of the flashlight is preferably made of a flexible yet tough material.

The fourth objective of the present invention is to provide a waterproof-breathable structure for a flashlight, wherein the housing is formed with a circular groove at a predetermined section on an outer periphery thereof circling around the hole penetrating the housing at the appropriate site, for receiving the abutting flange extending from the outer part of the ventilative plug assembled into the hole, and the rim extending from the inner part of the ventilative plug is separated from an inner wall of the housing by an appropriate interval, which allows the pressure generated inside the flashlight to be guided out easily.

The fifth objective of the present invention is to provide a waterproof-breathable structure for a flashlight, wherein the hole penetrating the housing at the appropriate site of the housing of the flashlight has an outer periphery formed with a circularly chamfered segment, which guides the ventilative plug to enter the hole smoothly, and facilities release of the pressure generated inside the flashlight.

### BRIEF DESCRIPTION OF THE DRAWINGS

The invention as well as a preferred mode of use, further objectives and advantages thereof will be best understood by reference to the following detailed description of illustrative embodiments when read in conjunction with the accompanying drawings, wherein:

FIG. 1 is an exploded view of a waterproof-breathable structure for a flashlight according to the present invention made from one viewpoint;

FIG. 2 is another exploded view of the waterproof-breathable structure according to the present invention made from another viewpoint;

FIG. 3 is a cross-sectional view of the unassembled waterproof-breathable structure according to the present invention;

FIG. 4 is a cross-sectional view of the assembled waterproof-breathable structure according to the present invention;

FIG. 4A is an enlarged view of Part A of FIG. 4;

FIG. 5 is a schematic, perspective view of the assembled waterproof-breathable structure according to the present invention;

FIG. 6 is a schematic drawing showing internal pressure released through the waterproof-breathable structure according to the present invention; and

FIG. 7 is a schematic drawing showing normal interference fit supported by the waterproof-breathable structure according to the present invention.

### DETAILED DESCRIPTION OF THE INVENTION

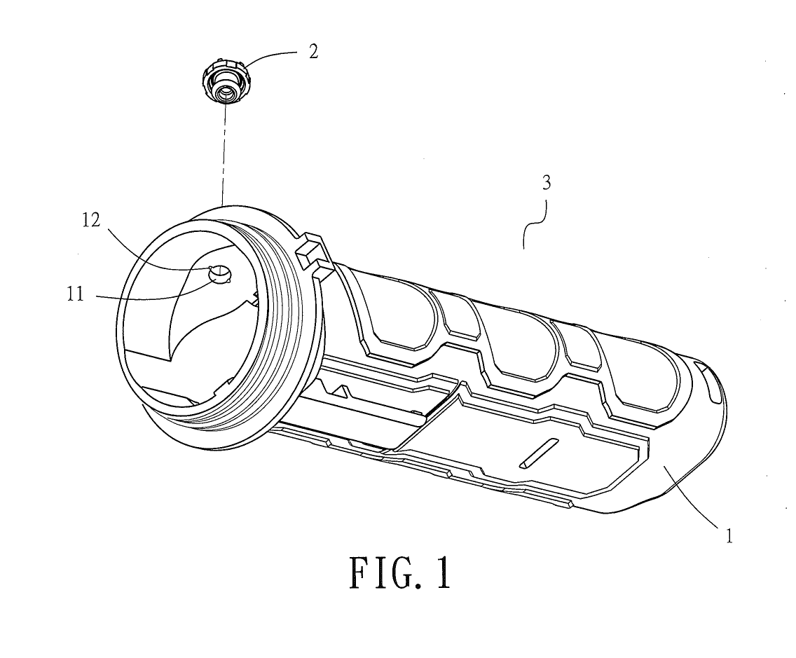

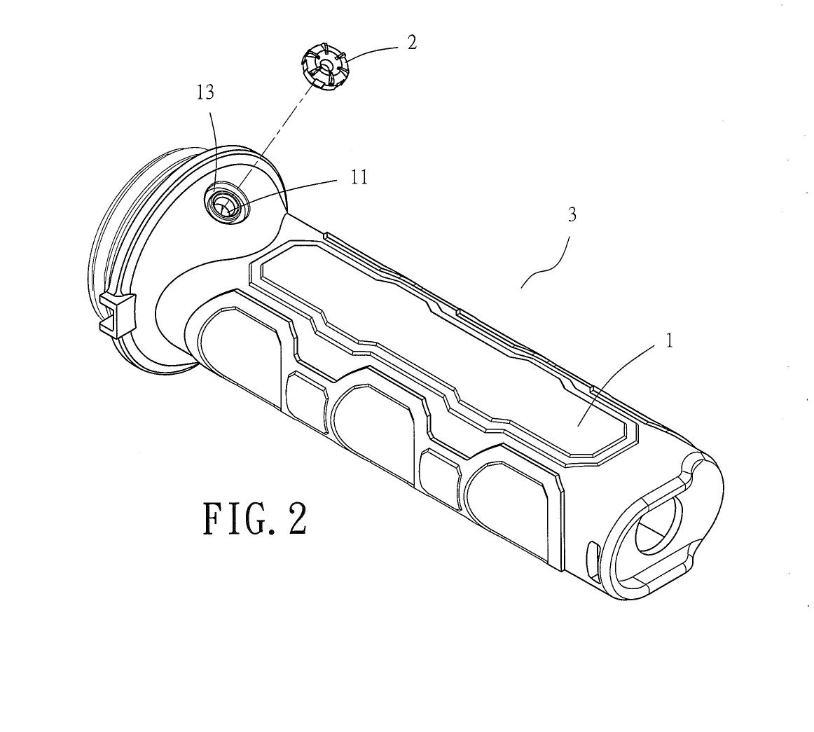

According to the present invention, a waterproof-breathable structure for a flashlight, as shown in FIG. 1 and FIG. 2, to make the flashlight (3) waterproof yet breathable, and includes a housing (1) and a ventilative plug (2).

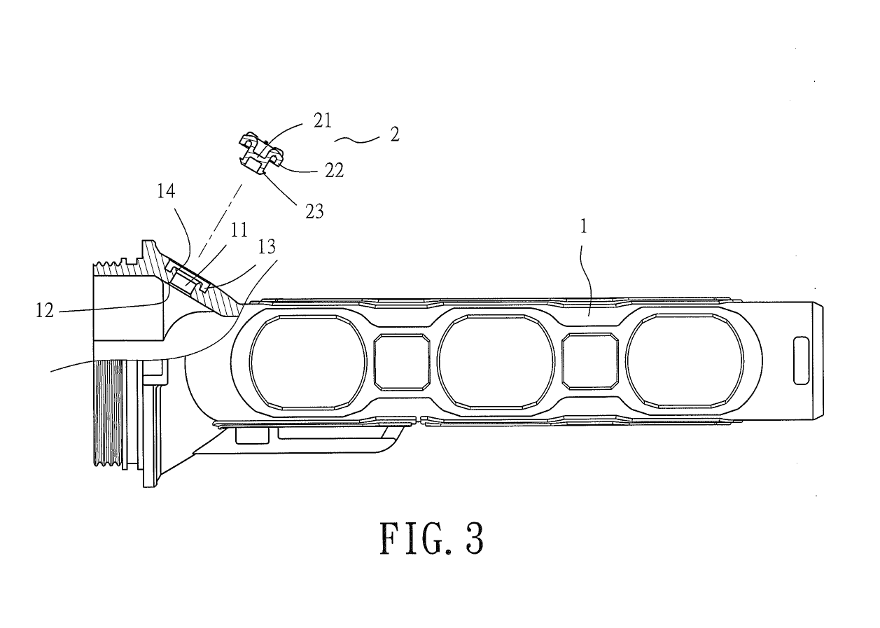

The housing (1) is at an appropriate site penetrated by a hole (11). The hole (11) has an inner periphery provided with one or more chamfered segments (12) (as shown in FIG. 1, two oppositely aligned chamfered segments). The housing (1) is formed with a circular groove (13) at a predetermined section on its outer periphery circling around the hole (11), as shown in FIG. 2 and FIG. 3. In addition, the hole (11) has a circularly chamfered segment (14) formed near the outer periphery of the housing (1).

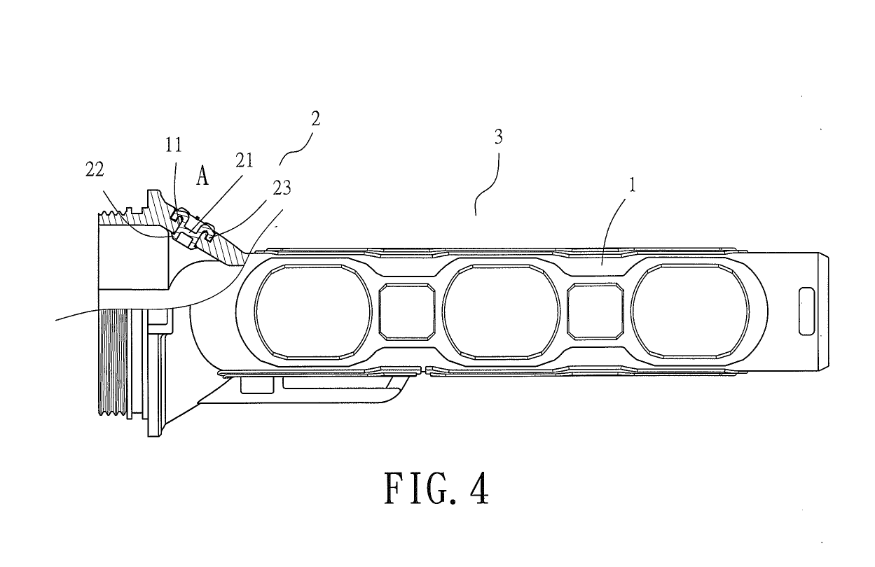

The ventilative plug (2) is dimensioned according to the hole (11) at the appropriate site of the housing (1) for a capping purpose. The ventilative plug (2) is preferably made of a flexible yet tough material. The ventilative plug (2) has a capping portion (21) at a predetermined section (the covering portion as shown having a thickness preferably smaller than 4 mm). The ventilative plug (2) has an abutting flange (22) extending from an outer part thereof and has a rim (23) extending from an inner part thereof, as shown in FIG. 4. Where the ventilative plug (2) contacts the housing hole (1) must achieve full roundness. Herein, the ventilative plug must have a middle segment greater than the housing hole (11), so that the ventilative plug can closely fit in the hole (11). The ventilative plug (2) when assembled in the housing hole (11) can form interference fit with the hole (11).

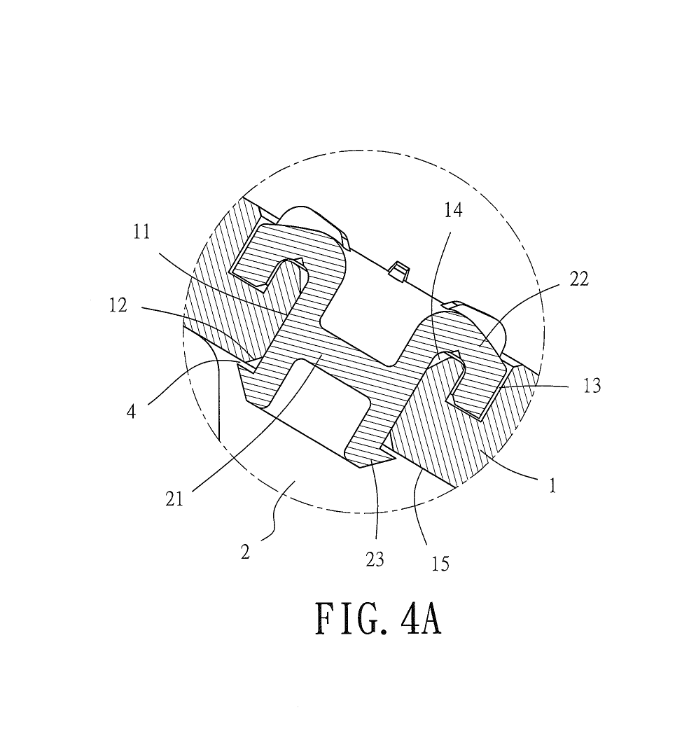

To assemble the flashlight housing (1) and the ventilative plug (2), referring to FIG. 3 and FIG. 4, the rim (23) at the inner part of the ventilative plug (2) is aligned with the circularly chamfered segment (14) at the outer periphery of the housing hole (11) and a force is applied to push the ventilative plug (2) into the housing (1), so that the abutting flange (22) at the outer part of the ventilative plug (2) is put in the circular groove (13) circling around the housing hole (11), as shown in FIG. 4A. The rim (23) extending from the inner part of the ventilative plug (2) is separated from the inner wall (15) of the housing (1) by an appropriate interval (4), which allows pressure generated inside the flashlight to be guided out easily. Thereby, upon completion of assembly of all the related components, the flashlight housing (1) possesses the desired breathability and waterproofability, as shown in FIG. 5.

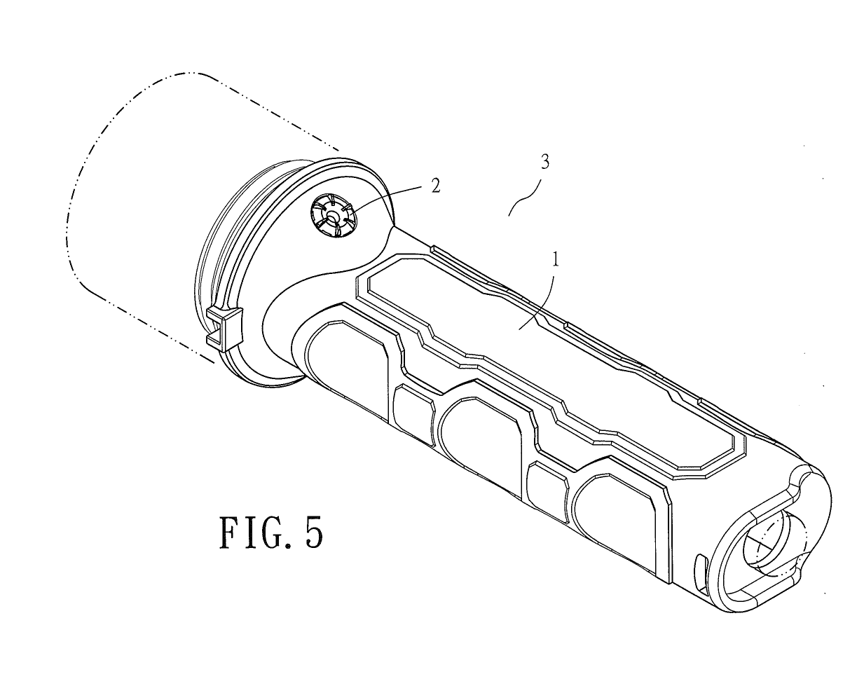

When the ventilative plug (2) sealing the flashlight housing (1) is affected by the inner pressure (5) generated in the flashlight (3) due to battery oxidation over time, referring to FIG. 6, the inner pressure (5) of the flashlight (3) pushes the capping portion (21) of the ventilative plug (2) outward and makes the latter bulged, in turn retracting the rim (23) at the inner part of the ventilative plug (2) inward. At this time, the inner pressure (5) can head out along the interval (4) formed between the periphery of the inward retracted ventilative plug (2) and the chamfered segments (12) at the inner periphery of the housing hole (11). Then the inner pressure (5) further progresses along the abutting flange (22) at the upper side of the ventilative plug (2) and the circularly chamfered segment (14) of the housing hole (11) to the exterior. Thereby, the flashlight in use meets the safety requirements (UL).

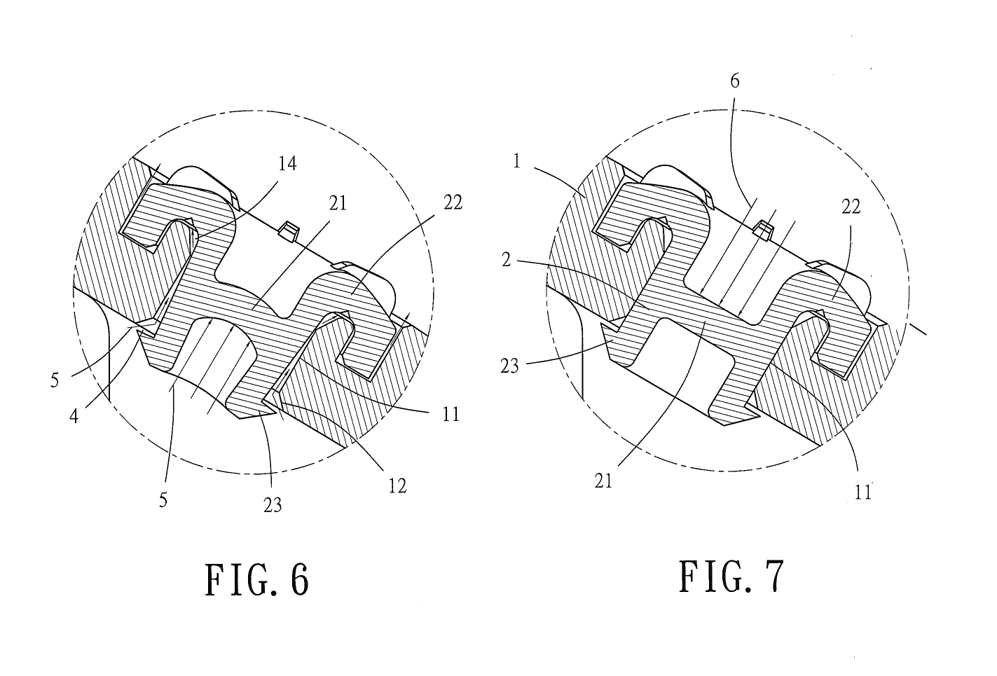

The ventilative plug (2) assembled to the flashlight housing (1) prevents external moisture (6) from incursion, referring to FIG. 7, by forming interference fit between the housing hole (11) and the ventilative plug (2), so as to effectively block external moisture (6) from incursion.

1. A waterproof-breathable structure for a flashlight, configured to make the flashlight waterproof yet breathable, comprising a housing having inside and outer peripheries and a ventilative plug, wherein the housing is at an appropriate site penetrated by a hole that has an inner periphery of a diameter and provided with a chamfered segment of a greater diameter than the inner periphery, wherein the ventilative plug has an outer diameter greater than the diameter of the inner periphery of the hole to be closely fit therein, wherein the ventilative plug has a capping portion at a predetermined section of the ventilative plug, an abutting flange formed on and extending from an outer part of the ventilative plug, and a rim formed on and extending from an inner part of the ventilative plug, with the abutting flange abutting with the outer periphery of the housing, with the rim abutting with the inside periphery of the housing, wherein the ventilative plug contacting the inner periphery of the hole achieves full roundness, wherein the ventilative plug when assembled in the hole forms an interference fit with the hole;
wherein inner pressure generated in the housing due to battery oxidation over time is allowed to escape through an interval formed between an inward retracted periphery of the ventilative plug and the chamfered segment formed at the inside periphery of the housing, while and wherein the ventilative plug closely fit in the hole of the housing serves to effectively prevent external moisture from incursion.

2. The waterproof-breathable structure of claim 1, wherein the capping portion at the predetermined section of the ventilative plug assembled into the hole of the housing of the flashlight has a thickness not greater than 4 mm.

3. The waterproof-breathable structure of claim 1, wherein the ventilative plug assembled into the hole of the housing of the flashlight is made of a flexible yet tough material.

4. The waterproof-breathable structure of claim 1, wherein the housing is formed with a circular groove at a predetermined section on the outer periphery circling around and spaced from the hole penetrating the housing at the appropriate site, with the circular groove receiving the abutting flange extending from the outer part of the ventilative plug assembled into the hole, with the rim extending from the inner part of the ventilative plug separated from an inner wall of the housing by an interval, which allows the inner pressure generated inside the housing to be guided out easily.

5. The waterproof-breathable structure of claim 1, wherein the hole penetrating the housing at the appropriate site of the housing of the flashlight has a circularly chamfered segment at the outer periphery of the housing, which guides the ventilative plug to enter the hole smoothly, and which facilities release of the inner pressure generated inside the housing.

6. The waterproof-breathable structure of claim 4, wherein the ventilative plug is of a tubular shape, with the capping portion located within the tubular shape and intermediate and spaced from the abutting flange and the rim.

7. The waterproof-breathable structure of claim 6, wherein the abutting flange is of an annular shape with L-shaped cross sections having a first leg connected to the outer part of the tubular shape of the ventilative plug and having a second leg extending concentrically around the tubular shape of the ventilative plug, with the second leg received in the circular groove of the housing.

8. The waterproof-breathable structure of claim 7, wherein the hole penetrating the housing at the appropriate site of the housing of the flashlight has a circularly chamfered segment at the outer periphery of the housing, which guides the ventilative plug to enter the hole smoothly, and which facilities release of the inner pressure generated inside the housing.

9. The waterproof-breathable structure of claim 7, wherein the rim is of an annular shape with triangular cross sections having a first surface generally parallel to the inside periphery of the housing and having a second surface extending from the first surface to the tubular shape of the ventilative plug.

10. The waterproof-breathable structure of claim 9, wherein the housing has a first end and a second end spaced from the first end, with the first end including outer threads adapted to receive a lens cap, with the hole located intermediate and spaced from the first and second ends.

11. The waterproof-breathable structure of claim 4, wherein the abutting flange is of an annular shape with L-shaped cross sections having a first leg connected to the outer part of the ventilative plug and having a second leg extending concentrically around the ventilative plug, with the second leg received in the circular groove of the housing.

12. The waterproof-breathable structure of claim 11, wherein the rim is of an annular shape with triangular cross sections having a first surface generally parallel to the inside periphery of the housing and having a second surface extending from the first surface to the ventilative plug.

13. The waterproof-breathable structure of claim 12, wherein the housing has a first end and a second end spaced from the first end, with the first end including outer threads adapted to receive a lens cap, with the hole located intermediate and spaced from the first and second ends.

14. The waterproof-breathable structure of claim 1, wherein the ventilative plug is of a tubular shape, with the capping portion located within the tubular shape and intermediate and spaced from the abutting flange and the rim.

15. The waterproof-breathable structure of claim 14, wherein the abutting flange is of an annular shape with L-shaped cross sections having a first leg connected to the outer part of the tubular shape of the ventilative plug and having a second leg extending concentrically around the tubular shape of the ventilative plug, with the second leg received in the circular groove of the housing.

16. The waterproof-breathable structure of claim 15, wherein the hole penetrating the housing at the appropriate site of the housing of the flashlight has a circularly chamfered segment at the outer periphery of the housing, which guides the ventilative plug to enter the hole smoothly, and which facilities release of the inner pressure generated inside the housing.

17. The waterproof-breathable structure of claim 15, wherein the rim is of an annular shape with triangular cross sections having a first surface generally parallel to the inside periphery of the housing and having a second surface extending from the first surface to the tubular shape of the ventilative plug.

18. The waterproof-breathable structure of claim 17, wherein the housing has a first end and a second end spaced from the first end, with the first end including outer threads adapted to receive a lens cap, with the hole located intermediate and spaced from the first and second ends.

19. The waterproof-breathable structure of claim 1, wherein the rim is of an annular shape with triangular cross sections having a first surface generally parallel to the inside periphery of the housing and having a second surface extending from the first surface to the ventilative plug.

20. The waterproof-breathable structure of claim 1, wherein the housing has a first end and a second end spaced from the first end, with the first end including outer threads adapted to receive a lens cap, with the hole located intermediate and spaced from the first and second ends.
